(19) United States
(12) Patent Application Publication
(10) Pub. No.: US 2007/0280919 A1
(43) Pub. Date: Dec. 6, 2007

(54) Produce-treatment composition and method for treatment of fresh produce

(76) Inventor: Stephen J. Gorton, Rowlett, TX (US)

Correspondence Address: BERENATO, WHITE & STAVISH, LLC, 6550 ROCK SPRING DRIVE, SUITE 240, BETHESDA, MD, 20817, US

(21) Appl. No.: 11/442,461

(22) Filed: May 30, 2006

(51) Int. Cl. A01N 65/00

(52) U.S. Cl. 424/94.3; 424/753; 424/754; 424/743; 424/767

(57) ABSTRACT

A produce-treatment composition is provided. According to an embodiment, the composition contains a nonionic surfactant, an antimicrobial agent, and a botanical extract from a plant selected from the Liliaceae and Cactus families, the extract retaining active enzymes and amino acids of the plant. Methods of treating produce and produce-handing and storage equipment are also provided.

### FIELD OF THE INVENTION

The present invention relates to compositions suited for surface treating and preserving produce, especially harvested, fresh produce such as vegetables, fruits, mushrooms, grains, and nuts. The present invention further relates to methods of making the produce-treatment compositions, and to methods of applying the produce-treatment compositions to harvested, fresh produce and to equipment which has come into contact with the produce.

### BACKGROUND OF THE INVENTION

There is a growing trend among consumers, especially health-conscious “baby-boomers,” to adjust their diets to consume greater amounts of fresh vegetables and fruits. The trend stems from the well known and accepted health benefits provided by fresh produce possessing high concentrations of essential vitamins and minerals. The trend is also attributed to diets proscribing high consumption of simple carbohydrates, thus requiring higher consumptions of fruits, vegetables and meats.

After harvest, vegetables and fruit have a limited shelf-life before deterioration deleteriously affects their palatability, nutritional value, odor, and aesthetic appearance. In more extreme circumstances deterioration can lead to food spoilage and create health risks to persons who consciously or unsuspectingly consume the spoiled produce. Many causes have been identified as attributing to deterioration, including the growth and high activity of micro-organisms, natural food enzyme activity, insects and other pests, and environmental conditions and changes, such as in temperature, moisture, and air quality. Many of the micro-organisms, at elevated levels, are pathogenic to humans when ingested. Citrus specific pathogens include, for example, Diplodia natalnesis (stem-end rot); Colletotrichum gloeasporioides (anthracnose); Penicillium digitatum (green mold); Geotrichum candidum; and more.

Problems stemming from the limited shelf-life of fresh produce are complicated by the fact that some fruits and vegetables are often seasonal or only grown at certain areas of the globe and therefore must travel considerable distances to reach intended consumers. The elapsed time period experienced in the transportation of the produce can exhaust a high proportion or all of the produce shelf-life, leaving the seller with an attenuated time period in which to sell the produce. Transportation modes and storage systems may subject the produce to various and divergent climates, which can accelerate deterioration and thereby further reduce shelf-life. Losses resulting from deterioration of the produce can impose heavy financial burdens on produce growers and harvesters who rely on high overall crop yields, groceries and other commercial marketplaces that seek to maximize commercial profitability, and consumers who depend on stable prices and continuous availability.

Refrigeration and controlled climate conditions are often employed during transportation, storage, and display of produce in an attempt to reduce spoilage and prolong shelf-life. While controlled environments limit the growth of food-borne organisms, such environments do not decontaminate produce previously inoculated with a biological contaminant, such as spoilage organisms and pathogenic bacteria. At the time of sale, the produce will retain the biological contamination, which, if left untreated, can be transported to and spread within the consumer's home.

Traditional remedies that have been used to prolong the shelf-life of fruits and vegetables include chemical bleach washes, alkaline-based washes, and treatment regimes using other chemicals such as sodium ortho phenyl phenate (SOPP), imazalil, and thiabendazole (TBZ). Each of these chemicals is corrosive and may pose underlying human health hazards. For example, heightened levels of imazalil and TBZ are believed to contribute to cancer and other long-term health problems. Some of these remedies have been discredited as largely ineffective and unnecessarily costly and time consuming. Further, educated consumers often are knowledgeable of the adverse consequences associated with these chemicals and will decline to purchase produce treated with these chemicals.

It would be a considerable advantage to produce growers, distributors, sellers, and consumers and others financially affected by produce quality if the deteriorating microbial infestations discussed above could be eliminated or at least substantially curtailed to meaningfully extend shelf-life. Therefore, there is an immediate and long-felt need for the technology of this invention, which in at least some preferred embodiments addresses the concerns noted above.

### SUMMARY OF THE INVENTION

In accordance with a first aspect of the invention, a produce-treatment composition is provided which features a produce-treatment composition, comprising a nonionic surfactant, an antimicrobial agent, and a botanical extract from a plant selected from the Liliaceae and Cactus families, the extract retaining active enzymes and amino acids of the plant.

A second aspect of the invention provides a method for the treatment of produce, featuring a step of contacting produce with an effective amount of a produce-treatment composition to treat microbial growth. The produce-treatment composition features a nonionic surfactant, an antimicrobial agent, and a botanical extract of a plant selected from the Liliaceae and Cactus families, the extract retaining active enzymes and amino acids of the plant.

According to a third aspect of the invention, a produce-treatment composition is provided, featuring aseptic water, a nonionic surfactant, and a botanical extract from a plant selected from the Liliaceae and Cactus families, the extract retaining active enzymes and amino acids of the plant.

A fourth aspect of the invention provides a method for the treatment of produce, comprising a step of contacting produce with an effective amount of a produce-treatment composition to treat microbial growth. The produce-treatment composition features aseptic water, a nonionic surfactant, and a botanical extract of a plant selected from the Liliaceae and Cactus families, the extract retaining active enzymes and amino acids of the plant.

According to a fifth aspect of the invention, a produce-treatment composition is provided. The composition features an enzyme, a nonionic surfactant, an antimicrobial agent, a penetrant, mucilaginous polysaccharides, and amino acids.

A sixth aspect of the invention provides a method for the treatment of produce, comprising the step of contact produce with an effective amount of a produce-treatment composition to treat microbial growth. The produce-treatment composition features an enzyme, a nonionic surfactant, an antimicrobial agent, a penetrant, mucilaginous polysaccharides, and amino acids.

A seventh aspect of the invention provides a method for treatment of surface areas (for example, of equipment, storage containers, etc.) that have or are anticipated to come into contact with fresh produce. Such surface areas may include, for example, industrial and packhouse equipment. Surface treatment may be performed before, during, or after the equipment has been contacted with produce. The above compositions of the first, third, and fifth aspects are particularly preferred for carrying out this method.

Other aspects of making the invention, including additional compositions and methods, will become apparent from the following detailed description.

### BRIEF DESCRIPTION OF THE DRAWING

The accompanying drawing is incorporated in and constitutes a part of the specification. The drawing, together with the general description given above and the detailed description of the preferred embodiments and methods given below, serve to explain the principles of the invention. In such drawing:

FIG. 1 is a bar graph showing the efficacy against green mold of a produce-treatment composition of an embodiment of the invention compared to a control and imazalil.

### DETAILED DESCRIPTION OF PREFERRED EMBODIMENTS AND PREFERRED METHODS OF THE INVENTION

Reference will now be made in detail to the preferred embodiments and methods of the invention. It should be noted that the invention in its broader aspects is not limited to the specific details, representative compositions and methods, and illustrative examples described in connection with the preferred embodiments and preferred methods. The invention according to its various aspects is particularly pointed out and distinctly claimed in the attached claims read in view of this specification, and appropriate equivalents.

According to a first preferred embodiment of the invention, the produce-treatment composition is an aqueous based biocide. As used herein, the terms biocide and antimicrobial shall mean to function as a fungicide and/or bactericide by eradicating or reducing existing bacterial and/or fungal growth, and/or preventing, suppressing, and/or inhibiting the infestation or recurrence of bacteria and fungus on a surface, e.g., of fresh produce or related equipment. Similarly, treatment of microbial growth may involve eradication or reduction of existing bacterial and/or fungal growth, and/or preventative or inhibition of infestation or recurrence of bacteria and fungus.

Water is the principal ingredient of the produce-treatment composition, preferably constituting at least about 8 weight percent up to about 35 weight percent, more preferably about 25 to about 30 weight percent of the composition in its ready-to-used form. It should be understand that the composition may be further diluted with additional water or by combining the composition with rinse water, for example. The final concentration of water and other constituents will depend upon the intended application of the formulation. Distilled, aseptic water free of minerals, ions, and ion exchange components is preferred for preventing denaturing of active ingredients.

Water containing ions from salts and minerals has a denaturing effect on proteins, amino acids, and enzymes. To prevent or at least retard the denaturing effect, the produce-treatment composition preferably includes at least one nonionic surfactant, preferably present in an effective amount to disperse enzyme or enzymes of the produce-treatment composition homogeneously in the aqueous solution. Numerous nonionic surfactants are known in the art and are suitable for use with the present invention. A preferred class of nonionic surfactants is ethoxylated surfactants, such as addition products of ethylene oxide with fatty alcohols, fatty acids, fatty amines, etc. Optionally, ethylene oxide may be replaced with a mixture of ethylene oxide and propylene oxide for the addition reaction. For the purposes of this and other embodiments, especially preferred nonionic surfactants include those selected from the group consisting of fatty acid (C₁₂₋₁₈) esters of sorbitan and fatty acid esters of ethoxylated (EO₅₋₁₀₀) sorbitans. More preferably, the surfactant is selected from mixtures of laurate esters of sorbitol and sorbitol anhydrides (sorbitan); mixtures of stearate esters of sorbitol and sorbitol anhydrides; and mixtures of oleate esters of sorbitol and sorbitol anhydrides. Representative commercially available surfactants falling within these categories include the following: polysorbate 20, which is a mixture of laurate esters of sorbitol and sorbitol anhydrides consisting predominantly of the monoester, copolymerized with about 20 moles of ethylene oxide (polyoxyethylene (20) sorbitan monolaurate); polysorbate 40 (polyoxyethylene (20) sorbitan monopalmitate); polysorbate 60 (polyoxyethylene (20) sorbitan monostearate); polysorbate 80 (polyoxyethylene (20) sorbitan monooleate); and any combination thereof. It should be understood that the above examples are not exhaustive. Other nonionic surfactants may be used in addition to or instead of the above sorbitan/sorbitol esters, provided that the surfactants are compatible with the other components of the composition and the selected pH, which preferably is within a range of 3.0 to 4.5. It is preferred to select low sodium, non-foaming or low foaming surfactants. For example, decyl glucoside is a suitable nonionic surfactant.

Although the solution is preferably free of surfactants other than nonionic surfactants, optionally one or more anionic surfactants may be mixed with the nonionic surfactant(s). In the case of a surfactant mixture, the nonionic surfactants preferably sufficiently dominate the surfactant mixture to prevent the anionic surfactant(s) from destabilizing the enzymes. Examples of anionic surfactants that may be used in combination with nonionic surfactants are sodium laureth sulfate and sodium lauroyl lactylate.

The surfactant component, including both the nonionic surfactant and optionally other surfactants, is present in a sufficient amount to help stabilize the enzymes, and preferably constitutes at least 20 weight percent of the total weight of the biocide composition. More preferably, the total amount of surfactants in the solution is in a range of about 25 weight percent to about 35 weight percent, although amounts up to 45 weight percent and higher may be employed. Preferably the ionic surfactant constitutes no more than about 5 weight percent of the total weight of the composition, more preferably about 1 to about 4 weight percent. The weight ratio of nonionic surfactant to anionic surfactant preferably is at least 4:1 or at least 6:1, depending upon the surfactants selected.

The produce-treatment composition desirably includes an antimicrobial agent (or preservative) in an effective amount to prevent or substantially reduce the degree to which microorganisms present in the composition denature the enzymes and breakdown other organic compounds, e.g., amino acids. The antimicrobial agent preferably yet optionally constitutes about 0.0001 weight percent to 5.0 weight percent, more preferably at least about 0.001 weight percent, and still more preferably at least about 0.01 weight percent of the total weight of the biocide. The selected agent preferably retains all or most of its effectiveness at the selected pH. Preferably, the antimicrobial agent also is safe to humans at the above concentrations, and does not present serious environmental hazards. Representative preservatives suitable for use with this and other embodiments include sodium benzoate, potassium sorbate, and methyl paraben. The preservative is preferably water-soluble.

The surface-treatment composition of this embodiment further includes an extract or processed form of a plant of the family Liliaceae, preferably the genus Aloe and/or Lilium, and/or a plant of the Cactus family, preferably Opuntia. The selected species preferably comprises a cold-processed extract containing enzymes, amino acids, lignins, mannan, and mucilaginous polysaccharides. The composition preferably contains about 2 weight percent to about 25 weight percent extract, more preferably about 5 weight percent to about 10 weight percent.

The genus Aloe encompasses approximately 600 species of plant. Preferred yet not exclusive species of the genus Aloe useful for the purposes of this invention include, for example, Aloe barbadensis Miller, also more commonly known as Aloe vera, Aloe arbrorescens, Aloe arborescenes natalensis, Aloe plicatis, and Aloe ferox Miller. Aloe barbadensis Miller is particularly preferred. Aloe barbadensis Miller is native to the Mediterranean region, but also widely distributed in southern parts of North America (especially Mexico), Europe, and Asia. The center of the aloe leaf contains a clear mucilaginous gel or mucilage that is visually distinguishable from the mucilaginous yellow juice known as aloin present about the base of the plant leaves and adjacent the rind of the leaf. The extract and juice of Aloe barbadensis contain over 75 components, including various enzymes, mucilaginous polysaccharides, lipopolysaccharides, monosaccharides, amino acids, and lignin. Other components of the aloe include cholesterol, glycerol, glycerides, triglycerides, steroids, saponins, sterols, uric acid, and salicyclic acid. An example of a species falling within the Lilium genus is Lilium candidum.

Examples of species falling within the Opuntia genus include Opuntia strigil, Opuntia basilaris, Opuntia rufida, Opuntia phaeacanthra, Opuntia engelmannii, Opuntia erinacea, Opuntia humifusa, Opuntia phaecantha, Opuntia chlorotica, Opuntia polycanthra, Opuntia voilacea, Opuntia spinosbacca, Opuntia ilndheimeri, and Opuntia macrorhiza.

The botanical extract used in preferred embodiments of the invention is purchased from a supplier or processed under such conditions which substantially retain without denaturing the active enzymes of the plant. Common plant-based enzymes of aloe and other members of the Liliaceae and Cactus families include aliiase, alkaline phosphatase, amylase, carboxypeptidase, catalase, cellulase, lipase, and peroxidase. The extract may be obtained commercially or by processing using any of a variety of well known methods. Commercial sources of Aloe include American Aloe Produce, Inc., AloeAmerican Products, Inc., and Coats Aloe, International. A commercial source of Lilium is CBI Laboratories. Commercial sources of Opuntia include Oro Verde, Gordon Monnier of Mexico and CBI Laboratories, Inc. of Ft. Worth, Tex. Any part of the plant may be processed or extracted, such as the leaf, stem, or flower. The extract may be taken from the whole leaf or leaf center. The extract is preferably obtained using cold-processing or other technique that substantially preserves the natural mucilaginous polysaccharides, amino acids, and enzymes of the aloe with substantially no denaturing of the enzymes and substantially no breakdown of the amino acids. Heat processes, such as those in which the aloe or other plant is subject to elevated temperatures (e.g., greater than 150° F.-160° F. for more than 45-60 minutes) that cause sterilization of the plant enzymes are preferably avoided. According to an example of a whole-leaf process technique, the leaves obtained from the Aloe barbadensis Miller plant were ground, treated with 2% cellulase, cold-filtered (e.g., with activated carbon), preserved (e.g., with sodium benzoate and/or potassium sorbate), and optionally lyophilized. The lyophilized powder was reconstituted with the chromatography solvent prior to use. In another example, the exudate from Aloe barbadensis Miller leaves was suspended in water, followed by contact with an appropriate chromatography solvent (e.g., acetones) prior to use.

While the benefits of topical application of aloe for the treatment of inflammation, burns, abrasions, bruises, infection, and other skin conditions are known, the inventor has discovered that the inclusion of plants of the Liliaceae family (e.g., aloe) in the produce-treatment composition of this embodiment surprisingly enhances the antifungal and antibacterial activity of the composition.

Without wishing to be bound by any theory, it is believed that the improved antimicrobial activity realized by the addition of the botanical extract, manufactured preferably using the whole plant or leaf pursuant to a cold-process, to the composition embodied herein is attributable, at least in part, to the mucilaginous polysaccharides and amino acids found in extract, especially in the case of Aloe barbadensis and similar aloes. It has been estimated that Aloe barbadensis includes 20 of the 22 human required amino acids and 7 essential amino acids. It is believed that the mucilaginous polysaccharides and amino acids function as binding agents to increase the time that the cell wall of an offending fungus or bacteria is left exposed to the biocide, thereby providing the biocide with sufficient opportunity to lyse the cell wall and membrane.

It is further believed that the improved antimicrobial activity realized by the inclusion of aloe extract in the produce-treatment composition of this embodiment is attributable, at least in part, to lignin found in the extract. Without wishing to be bound by any theory, it is believed that lignin acts to enhance the penetrating efficiency power of the product and thereby increases its effectiveness by allowing a more effective means of contacting and penetrating the plasma membrane of fungi cell wall and bacteria cell walls.

The enzymes and amino acids of an aloe plant exist in an environment, i.e., the mucilage, having a pH falling in the range of about 4.3 to about 4.7. In order to preserve the activity of the enzymes and assist the nonionic surfactants in the stabilization of these enzymes, the biocide is preferably produced, maintained, and stored within a pH range which will not adversely affect the biologically active constituents of the produce-treatment composition and will allow the biologically active constituents to exhibit desired activity levels. The optimum pH range for the growth of a majority of species of bacteria is about 5.5 to 7.5, although bacteria may grow within a pH range of about 4.3 to about 8.5 if subjected to optimum moisture conditions and nutrient supplies. Similarly, fungus growth rates are dependent upon pH, nutrient availability, moisture, and temperature. Fungus grows at accelerated rates within a pH range of 5.0 to 7.0, and as high as 8.0. It is preferred to formulate and retain the biocide composition of the present invention at a pH range falling outside the metabolism pH range of these organisms.

It has been found particularly beneficial to position the pH of the biocide in a range of about 3.1 to about 4.5, more preferably a range of about 3.2 to about 4.3 using one or more pH adjusting agents, typically acidic agents. Below a pH of about 3.1 to 3.2, the enzymes, amino acids, and other optional ingredients may denature. On the other hand, the pH preferably is equal to or lower than about 4.5, more preferably about 4.3, to suppress microbial growth and preserve the solution.

Acidic pH adjusting agents suitable for positioning the pH of the produce-treatment composition within the above acidic ranges preferably include organic acids, and still more preferably fatty acids. The fatty acid may be saturated or unsaturated, straight, branched, or cyclic. Mixtures of fatty acids may be used. The fatty acids preferably are C₆ to C₁₈ fatty acids, more preferably C₁₀ to C₁₂. Representative fatty acids include decanoic (capric) acid, undecanoic acid, and dodecanoic (lauric) acid, hexadecanoic (palmitic) acid, and octadecanoic (stearic) acid. Other pH adjusting agents include organic acids such as salicylic acids, ascorbic acid, malic acid, citric acid anhydride, fumaric acid, acetic acid, lactic acid, and succinic acid, as well as non-organic acids, e.g., buffered phosphoric acid. Commercial sources of organic acids include CBI Laboratories, Inc. of Ft. Worth, Tex. and First City Chemical, Inc. of Garland, Tex. Commercial sources of citric acid anhydride include UNIVAR, Inc. of Seattle, Wash. and CBI Laboratories, Inc. of Ft. Worth, Tex. The pH adjusting agent is used in a sufficient amount to obtain the desired pH. Usually, about 0.1 weight percent to about 3.0 weight percent of the pH adjusting agent will suffice.

The produce-treatment composition embodied herein may contain one or more additional components such as additional enzymes, enzyme blends, corrosion inhibitors, dyes, fragrances (e.g., lemon grass, vanilla, peach, tangerine, citrus, etc.), hydrotropes, suspending agents (e.g., propylene glycol), hydrophobic dispersants/cleaning agents (e.g., food-grade delimonene, turpines available from CBI Laboratories of Ft. Worth Tex. and Athea Laboratory, Inc. of Milwaukee, Wis.), coloring agents, odor neutralizers, buffers, and others compatible with the composition.

Without wishing to be bound by theory, it is believed that the enzymes present in the produce-treatment composition break down the lipo-polysaccharide/amino acid/lipid cell wall and/or membrane of an offending bacteria, fungus, mycelium, spore, enterobacteria, or other microorganism (e.g., Aspergillus spp, Penicillium spp, Cladosporium, E Coli, Pseudomonas spp, Staphylococcus aureus, Aspergillus spp, Salmonella spp, etc.), and neutralize the same via a lysing mechanism. Preferably, the enzyme comprises one or more members selected from amylase, lipase, cellulase, and protease. Lipase and amylase are preferably selected for penetrating the polysaccharide outer walls and lipid membranes of fungi and bacteria. When protease is selected, it is preferably used in combination with lipase. Other enzymes, such as carboxypeptidase, may be employed for use alone or in combination with the above enzymes, e.g., to enhance the enzymatic efficacy of the composition. In an especially preferred embodiment, the surface-treatment composition includes amylase, lipase, cellulase, and protease.

The selected concentration of enzymes in the solution may be influenced by various factors, including the activity of the enzymes, and the intended environment in which the produce-treatment composition will be used. Generally, the enzymes should be present in the biocide in a concentration of at least 0.01 weight percent of the total composition weight. Preferably, the enzyme concentration in the composition is selected in a range of about 0.1 weight percent to about 15 weight percent, such as in a range of 0.1 weight percent to 5.0 weight percent. The biocide may have, for example, a proteolytic activity between about 2,000 and 4,000 hut/gram, a lipolic activity between about 300 and 600 fip/gram, an amylotic activity between about 1,000 and 2,000 skb/gram, and a cellulolytic activity between about 450 and about 900 cu/gram, although it is within the scope of the invention to employ lower or higher activities. Typically, commercial suppliers will report the activity of their enzymes. Alternatively, the enzyme activity may be determined using established methods. High activities of enzyme concentrates available from commercial sources may be diluted for use in the biocide.

Enzymes added to the composition are preferably biologically derived fungal origin enzymes. Purified or non-purified forms of these enzymes may be used. In accordance with common practice, wild-type enzymes derived from pure cultures may be modified via protein genetic engineering techniques in order to optimize their performance efficiency for the compositions and methods of the invention. For example, the variants may be designed such that the compatibility of the enzyme(s) with other ingredients of the composition is increased. Alternatively, the variant may be designed such that the optimal pH, stability, catalytic activity and the like, of the enzyme variant is tailored to suit the particular cleaning application.

Proteases are effective in hydrolyzing or breaking down proteins. Proteases useful for the purposes of the present invention may be derived from a variety of sources, including microorganisms such as those of genus Aspergillus and Bacillus. Particularly useful proteases include those of fungi origin Aspergillus oryzae and Aspergillus niger and bacteria origin Bacillus subtilis and Bacillus licheniformis. Amylases are carbohydrate-hydrolyzing enzymes effective in breaking down starches into sugars. Useful amylases may be obtained from a wide variety of sources, including, for example, Aspergillus and Bacillus microorganisms such as Aspergillus oryzae and Bacillus subtilis, respectively. Lipase is a glyceride-hydrolyzing enzyme capable of breaking down a broad range of fat, grease, oil, and other hydrophobic material. Lipases may be prepared, for example, from certain fungi, such as Rhizopus oryzae. The lipase also serves to remove non-organic contaminants from the produce surface. Cellulases are cellulose-hydrolyzing enzymes. Cellulases include one or more subcategories of enzymes which hydrolyze subcategories of cellulose, such as endocellulases, exocellulases, beta-1,3-glucanases, and beta-glucosidases. Preferred cellulases may be prepared, for example, from fungi, such as Trichoderma longibrachiatum and Aspergillus niger. Commercial sources of biologically derived enzymes are well known in the art, and include, for example, Bio-Cat, Inc. of Troy, Va., Deerland Chemical, Deerland Enzymes, Inc. of Kennesaw, Ga., and MedipharmUSA of Des Moines, Iowa. Plant-based enzymes may be obtained from well known sources, such as Coats Aloe, International, Inc. of Dallas, Tex.

According to another embodiment of the invention, the botanical extract is replaced in whole or part with one or more alternative sources of enzymes, amino acids, mannans, mucilaginous polysaccharides, and/or penetrants.

Mucilaginous polysaccharides have biological and physical properties that make them useful in a variety of applications as ingredients of cosmetic, beverage, and pharmaceutical formulations and viscosifiers in chemical production processes. For the purposes of this embodiment, mucilaginous polysaccharides are generally meant to include mucilaginous polysaccharide biopolymers characterized by hetero or polysaccharide chains, either linear or branched, having acetyl, nitrogen acetyl, or other nitrogen functional groups associated with the main polysaccharide chain, and containing protein chemically bound to one or more of the external hydroxyl (—OH) groups of the main structure of the polysaccharide chains. Alternative sources include, for example, any plant (e.g., Plantago ovata, Plantago major) and cultured microorganisms (e.g., Coriolus versicolor, Shiitake, Maitake) containing mucilaginous polysaccharides. A description of mucilaginous polysaccharides and methods of isolating the same is provided in U.S. Pat. No. 6,482,942, which is incorporated herein by reference. Preferably, the mucilaginous polysaccharides constitute about 0.005 to about 3.0 weight percent of the composition of this embodiment.

Lignin increases the penetration efficacy of the composition enzymes. Lignin is one of the most abundant organic materials in nature and is the so-called “glue” in the cellulosic skeleton, which provides strength and support to trees and other plants. Lignin is also a major by-product of wood pulp processing in mills and, as such, is widely available. There are various lignin compounds that may be suitable for use with this embodiment, including lignosulphonates, Kraft lignins, oxylignins, and combinations and derivatives thereof. An example of a commercially available Kraft lignin is sold as INDULIN AT™. It is preferred that the lignin compounds constitute less than about 1 weight percent, more preferably about 0.001 to about 0.01 weight percent of the composition of this embodiment.

Alternative amino acid sources are plentiful, and may include, for example, soy protein oil and processed oats. Examples of amino acids that may be used include arginine, cystine, glycine, histidine, isoleucine, leucine, lysine, methionine, phenylalanine, threonine, typtophan, tyrosine, valine, serine, aspartic acid, and glutamic acid. Commercial suppliers of amino acid sources include SoLae, Inc. of Decatur, Ill. and Marcor, Inc. of Carlstadt, N.J.

The above-embodied compositions are in their preferred form comprised of a combination of safe, generally non-toxic organic enzymes and other components using natural, plant-derived enzymes and/or enzymes preferably derived from fungi. Without wishing to be bound by theory, it is believed that the embodied compositions break down polysaccharide cell walls, after which the enzymes destroy and neutralize the protein content of the offending fungi, bacteria, spores, and mycelium as well as any extracellular surface proteins. Without wishing to be bound by any theory, it is believed that this residue protects the produce from microbial re-growth and spore germination.

An embodiment of a method of making the produce surface-treatment biocide will now be described in detail. It should be understood that the embodiment described below may be modified and changed, and further that many additional methods exist and may be employed for making the inventive composition.

The sequence of combining the constituents or ingredients with one another may vary. However, there are several procedures and conditions that optionally yet preferably are practiced in carrying out the method.

It is preferred to establish the nonionic surfactant at the desired pH range, such as by the addition of fatty acids, prior to introducing the aloe and enzyme/enzyme blend into the composition. The nonionic surfactant is preferably mixed with other optional ingredients, such as emulsifiers, cleaning agents, and suspending agents prior to the introduction of the botanical extract and enzyme(s).

Added enzymes preferably are provided in distilled, demineralized water that has been steam processed, is pure, and contains no mineral ions, such as calcium minerals, or ionic exchange components capable of denaturing the proteins in solution. The enzymes are preferably dispersed in aseptic water. Another preference is to maintain the botanical extract and optionally added enzymes at a temperature below about 90° F.

The use of cold processing to blend the liquid solution with the enzymes, plant-based materials, amino acids, and mucilaginous polysaccharides increases the efficacy of the formulation and helps stabilize the proteins. Flash-heating (e.g., up to 150° F. for less than 45 to 60 minutes) may be employed to make the aloe aseptic. Heating these components above approximately 150° F. for more than about 45 minutes may destroy or denature the enzymes.

The produce-treatment composition preferably is free of alcohols and other ingredients that denature proteins and enzymes. Additionally, the produce-treatment composition preferably is free of active biologicals, including gram positive bacteria, such as Bacillus subtilis and fungi such as Aspergillus oryzae and Aspergillus niger.

Prior to its use, the produce-treatment composition is preferably stored and transported under moderate conditions, preferably within a temperature range of about 32° F. to about 104° F., preferably about 45° F. to about 90° F. Also, the biocide preferably is contained in a relatively non-humid environment, and still more preferably is placed in hermetically sealed, insulated containers. It is also preferred to store and transport the composition as a concentrate, diluting with water on site.

Another embodiment of the invention involves a method for the treatment of produce against fungal and bacterial growth, spore germination, mycelium growth, and resistant strains of penicillium and MRSA (antimicrobial resistant staphylococcus aureaus). The treatment method extends to the removal, prevention, reduction, and/or resistance to recurrence of microbial growth on fresh produce, preferably post-harvest. Examples of produce that may be treated using the method and composition of the invention include fruit (e.g., citrus fruit, melons, apples, grapes, tomatoes, avocados, peaches, etc.), vegetables (e.g., potatoes, carrots, lettuce, etc.), mushrooms, stored grain (e.g., soybean, corn maze, etc., nuts (e.g., tree nuts, ground nuts, peanuts, etc.), and the like. The treatment method also extends to preventative and active treatment of equipment surfaces that have come into contact or are anticipated to come into contact with the produce.

Generally, the method involves contacting a produce surface and/or surface areas of produce-handling and storage equipment with an effective amount of the biocide to treat microbial growth. The biocide may be applied to the surface in any known or suitable manner, including using application techniques such as spray, atomization, coating, immersion, ultrasonic, dip, drench, etc. The amount of composition applied to produce may vary widely depending upon application technique. By way of example only, one gallon of surface treatment composition may be sufficient for treatment of up to two tons of produce.

According to an embodiment of the invention, a standard spray application technique is employed to apply a liquid spray of the biocide to the produce. Standard spray equipment may be used. Preferably, the liquid spray primarily includes particles greater than fifteen (15) microns in size to prevent the occurrence of bacteria and fungi growth and spore germination. According to another embodiment, an atomization fumigation technique is employed for application of the biocide. The atomization fumigation application involves misting the biocide into particles of about 7 microns to about 15 microns in size and contacting the particles against the produce. Commercial equipment, such as manufactured by FMC, may be used for spraying or atomizing the biocide. Especially useful examples of commercial equipment include the Model 7808 NOZ-L-JET atomizer of Fogmasters, Inc. of Deerfield Beach, Fla. and the 534 Specialty Fogger/atomizer of Lafferty Equipment Manufacturing, Inc. of North Little Rock, Ark. The equipment preferably does not contain copper and/or brass components that might come into contact with and denature the biocide. Such components may be replaced with stainless steel, polytetrafluoroethylene, or polyvinylchloride. According to one preferred embodiment, the composition is applied via atomization up to 3 to 15 feet away from the produce.

The contact time between the produce-treatment composition and the produce is preferably at least 24 hours, more preferably about 24 hours to about 48 hours, although shorter or longer contact times may be selected. The contact time will depend upon several interdependent variables, including the amount and type of fungus and other contamination on the surface to be cleaned, the effectiveness of the particular application technique employed, transportation time for the produce to reach its destination for sale, among other factors. Because the produce-treatment composition is preferably safe to ingest, removal of the composition is optional. Composition removal, if desired, can be accomplished using known techniques, such as rinsing the produce with water. Treatment may be repeated if desired. Further, the embodied treatment may be combined with other products and agents, including an initial washing cycle, e.g., with water. Optionally, the produce may be subjected to pre-treatment or post-treatment. Multiple different biocide compositions may be applied simultaneously or consecutively.

### EXAMPLES

Examples of produce-treatment biocides and methods of making the same will now be described in detail. It should be understood that the following compositions and methods are exemplary, but not exhaustive.

A dry enzyme blend having the composition set forth in Table 1 was hydrolyzed in distilled water to provide a solution of 10 weight percent enzyme blend in water.

TABLE 1

| Enzyme | Type Derived | Source | Units (gram⁻¹) | |
|---|---|---|---|---|
| Cellulase | Fungal | Trichoderma | 5,000 | cu/gram |
| | | longibrachiatum | | |
| Cellulase | Fungal | Aspergillus niger | 4,000 | cu/gram |
| Amylase | Fungal | Aspergillus oryzae | 20,000 | skb/gram |
| Protease | Fungal | Aspergillus oryzae | 40,000 | hut/gram |
| Lipase | Fungal | Rhizopus oryzae | 3,000 | fip/gram |
| Lipase | Yeast | Candida cylindracea | 3,000 | fip/gram |

A produce-treatment composition according to an embodiment of the invention was then prepared to have the formulation set forth in Table 2 below.

TABLE 2

| | | | | |
|---|---|---|---|---|
| Phase | Ingredient | Function | pbw | Range (+/−) |

Initial Temperature 40-45° C.

| | | | | |
|---|---|---|---|---|
| 1 | Polysorbate-20 | Nonionic surfactant | 24.00 | 2.00 |
| 1 | Polysorbate-80/Tween80 | Nonionic surfactant | 8.0 | 2.00 |
| 1 | Ionic/Anionic | Surfactant | 5.0 | 1.0 |
| 1 | Undecylenic acid | pH Adjuster | 1.00 | 0.005 |
| 1 | Scorbic (derived from | pH Adjuster | 1.00 | 0.05 |
| | citrus extract) | | | |
| 1 | Sodium benzoate | Preservative | 1.00 | 0.025 |
| 1 | Potassium sorbate | Preservative | 1.00 | 0.025 |
| 1 | Methylparaben | Preservative | 2.00 | 0.025 |

Adjusted Temperature to 30-35° C.

| | | | | |
|---|---|---|---|---|
| 2 | Aloe barbadensis | Mucilage, amino acids | 20.00 | 3.0 |
| | | mucopolysaccharides, | | |
| | | lignins | | |
| 2 | Potassium sorbate | Aloe Preservative | 1.00 | 0.01 |
| 2 | Sodium benzoate | Aloe Preservative | 1.00 | 0.01 |

Adjusted Temperature to 20-25° C., adjust pH to 3.3-3.8 with phosphoric acid

| | | | | |
|---|---|---|---|---|
| 3 | Enzyme blend | Active Agent | 10.00 | 0.020 |
| 3 | Distilled Water | | 30.00 | 0.30 |
| 3 | Phosphoric acid (75) | pH Adjustment | | |
| | and/or citric acid | | | |
| | anhydrous | | | |
| 3 | Sodium benzoate | Preservative | 2.0 | 0.001 |
| 3 | Methylparaben | Preservative | 2.0 | 0.025 |

Adjust pH with phosphoric acid (75M) and citric acid anhydrous to 3.3-3.8

The surfactants, organic acids, and preservatives were combined together and maintained at 40-45° C. for about 2 hours until completely solubilized. The organic acids were used to adjust the pH to 3.2 to 4.5. The solution was allowed to cool to 30-35° C., and cold-processed and preserved Aloe barbadensis (28×/40× polysaccharide/amino acids) was added. Distilled (non-ionic) water and the aseptic enzyme solution were added subsequently in phase 3. Sodium benzoate was included to prevent the enzymes and proteins from denaturing. The solution was cooled to 20-25° C. and pH was adjusted to 3.3-3.8 with food-grade phosphoric acid. The produce-treatment composition of Table 2 is the subject of Examples 1-32.

### Examples 1-16

Cultures of the microorganisms Pseudomonas aeruginosa (ATCC No. 9027, Quality Technologies, Inc.), Escherichia coli (ATCC No. 8739, Quality Technologies, Inc.), Enterobacter cloacae (ATCC No. 13047, Quality Technologies, Inc.), Staphylococcus aureus (ATCC No. 6538, Quality Technologies, Inc.), Aspergillus niger (ATCC No. 16404, Quality Technologies, Inc), Aspergillus flavus (ATCC No. 26946, ATCC), Aspergillus parasiticus (ATTC No. 26863, ATCC), Penicillium species (in-house), Penicillium citrinum (ATCC No. 32006, ATTC), Klebsiella pneumoniae (ATCC No. 13882, Quality Technologies, Inc.), Salmonella typhimurium (ATCC No. 14028, Quality Technologies, Inc.), Streptococcus anginosus (ATCC No. 33397, Quality Technologies, Inc.), Rhizopus stolonifer (ATCC No. 14037, Quality Technologies, Inc.), and Penicillium digitatum were maintained as stock cultures from which working inocula were prepared. The viable microorganisms used were not more than five passages removed from the original stock culture, wherein one passage is defined as the transfer of organisms from an established culture to fresh medium. Plate preparation, inoculum and kill rate data collection were performed in accordance with ASTM E2315.03. All plate dilutions were performed in duplicate. See Murry, Patrick R., Ellen Jo Baron, James H. Jorgensen, Michael A. Pfaller and Robert H. Yolken, Assessment of bactericidal activity by the time-kill method, Manual of Clinical Micobiology, 8^{th} Edition, ASM Press, Washington, D.C. (2003) pp. 1187-1188.

A. Preparation of Inoculum:

1. Inoculate the surface of a suitable volume of solid agar medium from a recently grown stock culture of each of the microorganisms. Incubate the bacterial cultures at 35° C.±2° C. for 24-48 hours. Incubate the fungal cultures at 35° C.±2° C. for 2-7 days.

2. Determine the number of viable microorganisms in each milliliter of the inoculum suspensions by serial dilution in sterile 0.85% phosphate buffered saline, pH 7.2±0.2.

3. Plate dilutions of 10⁻³ to 10⁻⁸ in duplicate for test organisms.

4. Overlay with approximately 20 ml of 45° C. tryptic soy agar with lecithin and Tween 80, sabouraud dextrose agar or potato dextrose agar.

5. Incubate for 48-96 hours at 35° C.±2° C. for the aerobic organisms.

6. Count test organisms.

7. Calculate the number of organisms as colony forming units per ml (cfu/ml) of inoculum as follows:

$$\frac{cfu \text{/} ml ( 0.1 ml )}{9.9 ml} = cfu \text{/} ml of product$$

B. Preparation of Test Samples

1. Accurately pipette 9.9 ml of product into an appropriately labeled or coded test tube.

2. Store test samples at ambient room temperature.

C. Inoculation of Plating of Samples

1. Aseptically transfer 0.1 ml of the test organism into an appropriate labeled 9.9 ml sample of test material. The test organism was inoculated as a pure culture into a single 9.9 ml sample of test material.

2. Thoroughly mix or stir all samples.

3. Allow the samples to stand for one hour, twenty-four (24) hours, and forty-eight (48) hours.

4. Remove one milliliter aliquots at the indicated times and transfer to 9.0 ml sterile saline.

5. Perform serial dilutions from 10⁻¹ to 10⁻⁵.

6. Transfer 1.0 ml of each dilution into a 100×15 mm Petri plate.

7. Overlay with approximately 20 ml of 45° C. tryptic soy agar with lecithin and Tween 80, sabouraud dextrose agar or potato dextrose agar.

8. Gently swirl plates and allow to solidify.

9. Incubate plates for 48-96 hours at 35° C.±2° C.

D. Sample Evaluation

1. Read plates and record results on appropriate data sheet.

2. Using the calculated inoculum concentration for each test microorganism, calculate the log reduction for each microorganism to determine kill rate. The plates were done in duplicate and the kill rate number was the average of the two separate plates for each organism for each specified time period.

The kill rate results of bacterial, food-borne pathogens were as follows:

TABLE 3

| | | | Inoculum | Average | Log |
|---|---|---|---|---|---|
| Organism | Example | t (hr) | level | Growth | Reduction |
| P. aeruginos | 1 | 1 | 1 × 10⁵ | None | 5.00 |
| P. aeruginos | 1 | 24 | 1 × 10⁵ | None | 5.00 |
| P. aeruginos | 1 | 48 | 1 × 10⁵ | None | 5.00 |
| E. coli | 2 | 1 | 5.56 × 10⁵ | 10,605 | 1.72 |
| E. coli | 2 | 24 | 5.56 × 10⁵ | None | 5.75 |
| E. coli | 2 | 48 | 5.56 × 10⁵ | None | 5.75 |
| E. cloacae | 3 | 1 | 1.36 × 10⁵ | None | 6.13 |
| E. cloacae | 3 | 24 | 1.36 × 10⁵ | None | 6.13 |
| E. cloacae | 3 | 48 | 1.35 × 10⁵ | None | 6.13 |
| S. aureus | 4 | 1 | 3.54 × 10⁵ | None | 5.55 |
| S. aureus | 4 | 24 | 3.54 × 10⁵ | None | 5.55 |
| S. aureus | 4 | 48 | 3.54 × 10⁵ | None | 5.55 |
| K. pneumoniae | 5 | 1 | 1.01 × 10⁶ | None | 6.00 |
| K. pneumoniae | 5 | 24 | 1.01 × 10⁶ | None | 6.00 |
| K. pneumoniae | 5 | 48 | 1.01 × 10⁶ | None | 6.00 |
| S. typhimurium | 6 | 1 | 1.11 × 10⁶ | None | 6.05 |
| S. typhimurium | 6 | 24 | 1.11 × 10⁶ | None | 6.05 |
| S. typhimurium | 6 | 48 | 1.11 × 10⁶ | None | 6.05 |
| S. anginosus | 7 | 1 | 1.52 × 10⁵ | None | 5.18 |
| S. anginosus | 7 | 24 | 1.52 × 10⁵ | None | 5.18 |
| S. anginosus | 7 | 48 | 1.52 × 10⁵ | None | 5.18 |
| Campylobacter | 8 | 1 | 1.10 × 10⁶ | None | 6.00 |
| Campylobacter | 8 | 24 | 1.10 × 10⁶ | None | 6.00 |
| Campylobacter | 8 | 48 | 1.10 × 10⁶ | None | 6.00 |
| MRSA | 9 | 1 | 1.01 × 10⁶ | None | 6.00 |
| MRSA | 9 | 24 | 1.01 × 10⁶ | None | 6.00 |
| MRSA | 9 | 48 | 1.01 × 10⁶ | None | 6.00 |

The kill rate results of spore-forming fungi, spoilage organisms and pathogens were as follows:

TABLE 4

| | | | | | |
|---|---|---|---|---|---|
| A. niger | 10 | 1 | 2.98 × 10⁵ | 131,500 | 0.36 |
| A. niger | 10 | 24 | 2.98 × 10⁵ | None | 5.47 |
| A. niger | 10 | 48 | 2.98 × 10⁵ | None | 5.47 |
| A. flavus | 11 | 1 | 1.71 × 10⁵ | 92,000 | 0.27 |
| A. flavus | 11 | 24 | 1.71 × 10⁵ | None | 5.23 |
| A. flavus | 11 | 48 | 1.71 × 10⁵ | None | 5.23 |
| A. parasiticus | 12 | 1 | 3.27 × 10⁵ | 220,000 | 0.17 |
| A. parasiticus | 12 | 24 | 3.27 × 10⁵ | None | 5.51 |
| A. parasiticus | 12 | 48 | 3.27 × 10⁵ | None | 5.51 |
| Penicillium spp | 13 | 1 | 5.23 × 10⁴ | 68,500 | −0.12 |
| Penicillium spp | 13 | 24 | 5.23 × 10⁴ | None | 4.72 |
| Penicillium spp | 13 | 48 | 5.23 × 10⁴ | None | 4.72 |
| P. citrinum | 14 | 1 | 1.39 × 10⁶ | 1,450,000 | −0.02 |
| P. citrinum | 14 | 24 | 1.39 × 10⁶ | None | 6.14 |
| P. citrinum | 14 | 48 | 1.39 × 10⁶ | None | 6.14 |
| P. digitatum | 15 | 1 | 1.06 × 10³ | 450 | 0.37 |
| P. digitatum | 15 | 24 | 1.06 × 10³ | None | 3.03 |
| P. digitatum | 15 | 48 | 1.06 × 10³ | None | 3.03 |
| R. stolonifer | 16 | 1 | 6.31 × 10³ | None | 3.80 |
| R. stolonifer | 16 | 24 | 6.31 × 10³ | None | 3.80 |
| R. stolonifer | 16 | 48 | 6.31 × 10³ | None | 3.80 |

### Examples 17-32

Cultures of the microorganisms Aspergillus niger (ATCC No. 16404, Quality Technologies, Inc), Penicillium species (in-house), and Penicillium digitatum (in house), Pseudomonas aeruginosa (ATCC No. 9027, Quality Technologies, Inc.), and Diplodia natalemsis (in house) were maintained as stock cultures from which working inocula were prepared. The viable microorganisms used were not more than five passages removed from the original stock culture, wherein one passage is defined as the transfer of organisms from an established culture to fresh medium. Plate preparation, inoculum and kill rate data collection were performed in accordance with ASTM E2315.03. All plate dilutions were performed in duplicate.

A. Preparation of Inoculum:

1. Inoculate the surface of a suitable volume of solid agar medium from a recently grown stock culture of each of the microorganisms. Incubate the bacterial cultures at 35° C.±2° C. for 4-6 days.

2. Determine the number of viable microorganisms in each milliliter of the inoculum suspensions by serial dilution in sterile 0.85% at buffered saline, pH 7.2±0.2.

3. Plate dilutions of 10^{-6,} 10⁻⁷, and 10⁻⁸ for test organisms.

4. Overlay with approximately 20 ml of 45° C. tryptic soy agar with lecithin and Tween 80.

5. Incubate for 48-96 hours at 35° C.±2° C. for the aerobic organisms.

6. Count test organisms.

7. Calculate the number of organisms as colony forming units per ml (cfu/ml) of inoculum as follows:

$$\frac{cfu \text{/} ml ( 0.1 ml )}{9.9 ml} = cfu \text{/} ml of product$$

B. Preparation of Test Samples

1. Accurately pipette 9.9 ml of product into an appropriately labeled or coded test tube.

2. Store test samples at ambient room temperature.

C. Inoculation of Plating of Samples

1. Aseptically transfer 0.1 ml of the test organism into an appropriate labeled 9.9 ml sample of test material. The test organism was inoculated as a pure culture into a single 9.9 ml sample of test material.

2. Thoroughly mix or stir all samples.

3. Allow the samples to stand for one hour and twenty-four (24) hours.

4. Remove one milliliter aliquots at the indicated times and transfer to 9.0 ml sterile saline.

5. Perform serial dilutions from 10⁻¹ to 10⁻⁵.

6. Transfer 1.0 ml of each dilution into a 100×15 mm Petri plate.

7. Overlay with approximately 20 ml of 45° C. tryptic soy agar with lecithin and Tween 80.

8. Gently swirl plates and allow to solidify.

9. Incubate plates for 48-96 hours at 35° C.±2° C.

D. Sample Evaluation

1. Read plates and record results on appropriate data sheet.

2. Using the calculated inoculum concentration for each test microorganism, calculate the log reduction for each microorganism to determine kill rate.

The kill rate results for spore-forming fungi, spoilage organisms and pathogens were as follows:

TABLE 5

| | | | Inoculum | Average | Log |
|---|---|---|---|---|---|
| Organism | Example | t (hr) | level | Growth | Reduction |
| A. niger | 17 | 1 | 6.21 × 10⁵ | 7.5 × 10⁵ | −0.08 |
| A. niger | 17 | 24 | 6.21 × 10⁵ | None | 5.79 |
| Penicillium spp | 18 | 1 | 1.5 × 10⁴ | None | 4.18 |
| Penicillium spp | 18 | 24 | 1.5 × 10⁴ | None | 4.18 |
| P. digitatum | 19 | 1 | 1.01 × 10⁴ | None | 4.00 |
| P. digitatum | 19 | 24 | 1.01 × 10⁴ | None | 4.00 |
| D. natalemsis | 20 | 1 | 1.01 × 10⁴ | None | 4.00 |
| D. natalemsis | 20 | 24 | 1.01 × 10⁴ | None | 4.00 |
| A. niger | 21 | 1 | 6.21 × 10⁵ | 4.9 × 10⁶ | −0.90 |
| A. niger | 21 | 24 | 6.21 × 10⁵ | 4153 | 2.17 |
| Penicillium ssp | 22 | 1 | 1.5 × 10⁴ | 1118 | 1.13 |
| Penicillium ssp | 22 | 24 | 1.5 × 10⁴ | None | 4.18 |
| P. digitatum | 23 | 1 | 1.01 × 10⁴ | 70 | 2.16 |
| P. digitatum | 23 | 24 | 1.01 × 10⁴ | None | 4.00 |
| D. natalemsis | 24 | 1 | 1.01 × 10⁴ | 110 | 1.96 |
| D. natalemsis | 24 | 24 | 1.01 × 10⁴ | None | 4.00 |
| A. niger | 25 | 1 | 6.21 × 10⁵ | 6.0 × 10⁵ | 0.01 |
| A. niger | 25 | 24 | 6.21 × 10⁵ | None | 5.79 |
| Penicillium spp | 26 | 1 | 1.5 × 10⁴ | None | 4.18 |
| Penicillium spp | 26 | 24 | 1.5 × 10⁴ | None | 4.18 |
| P. digitatum | 27 | 1 | 1.01 × 10⁴ | None | 4.00 |
| P. digitatum | 27 | 24 | 1.01 × 10⁴ | None | 4.00 |
| D. natalemsis | 28 | 1 | 1.01 × 10⁴ | None | 4.00 |
| D. natalemsis | 28 | 24 | 1.01 × 10⁴ | None | 4.00 |

The kill rate results of bacteria, food-borne pathogens were as follows:

TABLE 6

| | | | | | |
|---|---|---|---|---|---|
| P. aeruginosa | 29 | 1 | 9.70 × 10⁵ | None | 5.99 |
| P. aeruginosa | 29 | 24 | 9.70 × 10⁵ | None | 5.99 |
| P. aeruginosa | 30 | 1 | 9.70 × 10⁵ | None | 5.99 |
| P. aeruginosa | 30 | 24 | 9.70 × 10⁵ | None | 5.99 |
| P. aeruginosa | 31 | 1 | 9.70 × 10⁵ | None | 5.99 |
| P. aeruginosa | 31 | 24 | 9.70 × 10⁵ | None | 5.99 |
| P. aeruginosa | 32 | 1 | 8.48 × 10⁵ | None | 5.96 |
| P. aeruginosa | 32 | 24 | 8.84 × 10⁵ | None | 5.96 |

A produce-treatment composition according to another embodiment of the invention was prepared to have the formulation set forth in Table 7 below.

TABLE 7

| | | | | |
|---|---|---|---|---|
| Phase | Ingredient | Function | pbw | Range (+/−) |

Initial Temperature 40-45° C.

| | | | | |
|---|---|---|---|---|
| 1 | Polysorbate-20 | Nonionic surfactant | 24.0 | 2.00 |
| 1 | Polysorbate-80/Tween80 | Nonionic surfactant | 8.0 | 2.00 |
| 1 | Ionic/Anionic | Surfactant | 5.0 | 1.0 |
| 1 | Undecylenic acid | pH Adjuster | 1.00 | 0.005 |
| 1 | Scorbic (derived from | pH Adjuster | 1.00 | 0.05 |
| | citrus extract) | | | |
| 1 | Sodium benzoate | Preservative | 1.00 | 0.025 |
| 1 | Potassium sorbate | Preservative | 1.00 | 0.025 |
| 1 | Propylparaben | Preservative | 2.00 | 0.025 |

Adjusted Temperature to 30-35° C.

| | | | | |
|---|---|---|---|---|
| 2 | Aloe barbadensis | Mucilage, amino acids | 20.00 | 3.0 |
| | | mucopolysaccharides, | | |
| | | lignins | | |
| 2 | Potassium sorbate | Aloe Preservative | 1.00 | 0.01 |
| 2 | Sodium benzoate | Aloe Preservative | 1.00 | 0.01 |

Adjusted Temperature to 20-25° C., adjust pH to 3.3-3.8 with phosphoric acid

| | | | | |
|---|---|---|---|---|
| 3 | Enzyme blend | Active Agent | 10.00 | 0.020 |
| 3 | Distilled Water | | 30.00 | 0.30 |
| 3 | Phosphoric acid (85M) | pH Adjustment | | |
| | and/or citric acid | | | |
| | anhydrous | | | |
| 3 | Sodium benzoate | Preservative | 2.0 | 0.001 |
| 3 | Propylparaben | Preservative | 2.0 | 0.025 |

Adjust pH with citric acid anhydrous to 3.0-4.3

In vitro antibiosis tests were carried out by incorporation of the formulation of Table 7 into potato dextrose agar (PDA) media at concentrations of 0, 0.2, 0.4, 0.6, 0.8, 1, 1.5, and 2 weight percent, respectively, in plates 10 cm in diameter. A PDA plug colonized with Penicillium digitatum (responsible for green mold) and Diplodia natalensis (responsible for stem-end rot on citrus fruit) was transferred to the center of the plates. The plates were incubated at 25° C.

In vivo efficacy tests for the formulation of Table 7 were carried out on Fallglo tangerines, pineapples, and Valencia oranges inoculated with Penicillium digtatum using a puncture method, in which the fruit was punctured with the tip of a 1 mm×1 mm probe that had been dipped into the inoculum solution (1×10⁶ fungal spores/ml). The fruit was then subject to either a dip treatment procedure or a packingline dip treatment procedure twenty to twenty-four hours after inoculation. The dip treatment procedure involved dipping the inoculated fruit into the composition for one (1) minute. The packingline dip treatment procedure involved treating the fruit with suspensions or wax containing the produce-treatment composition using a non-recovery drip system through a simulated commercial packing line. Fruits were rotated on brush beds and contacted with chemicals for 15 to 20 seconds, and then dried at 50-54° C. for 1-2 minutes. In both procedures, the treated fruit was incubated at 21° C. with 95% relative humidity.

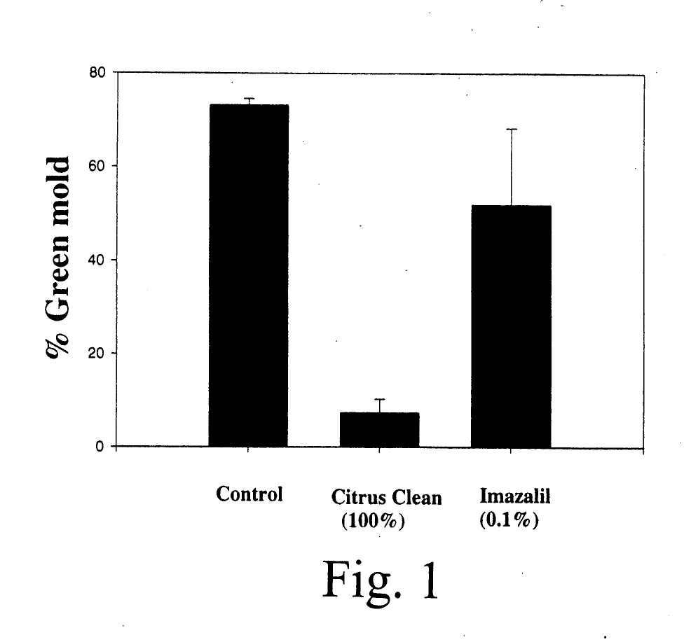

FIG. 1 depicts a bar graph reporting the efficacy of the produce-treatment composition of Table 7 to green mold (P. digitatum), and comparing the results to those of a control (distilled water) and 0.1% imazalil. The inventive formulation reduced green-mold incidences to just 8%, i.e., a 92% reduction, relative to untreated produce. The control and imazalil incidence results were 77% (i.e., a 23% reduction) and 51% (i.e., a 49% reduction), respectively.

Advantageously, produce-treatment compositions embodied herein have biocidal activity for reducing spoilage and losses of fruits, vegetables, and/or other fresh produce (e.g., nuts, mushrooms) caused by fungal and/or bacterial contamination. The compositions may be applied to fresh produce, for example, to eradicate or reduce existing harmful microbial (e.g., bacterial and/or fungal) growth on the surface, and preferably also to inhibit the infestation or recurrence of harmful microbes on the surface. The compositions and methods may be, and preferably are environmentally safe, and preferably are suitable for classification as in a generally recognized as safe (GRAS) status. Another consumer-safety benefit of the invention is that many of the organisms against which the inventive composition is effective are known human pathogens, such that treatment of the produce and/or equipment surfaces can prevent the spread of the pathogens to humans.

The foregoing detailed description of the certain preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims.

1-9. (canceled)

10. A method for the industrial treatment of produce, comprising:
contacting produce in an industrial process with an effective amount of a biocide to treat microbial growth, the biocide having a composition comprising a nonionic surfactant, an antimicrobial agent, and a botanical extract of a plant selected from the Liliaceae and Cactus families, the extract retaining active enzymes and amino acids of the plant.

11-12. (canceled)

13. A method for the treatment of a surface of industrial equipment, comprising:
subjecting produce to an industrial cleaning process with industrial equipment so that the produce comes into contact with a surface of the industrial equipment; and
contacting the surface of the industrial equipment which has come into contact with the produce with a biocide, the biocide having a composition comprising a nonionic surfactant, an antimicrobial agent, and a botanical extract of a plant selected from the Liliaceae and Cactus families, the extract retaining active enzymes and amino acids of the plant.

14-15. (canceled)

16. A method for the industrial treatment of produce, comprising:
contacting produce in an industrial process with an effective amount of biocide to treat microbial growth, the biocide having a composition comprising aseptic water, a nonionic surfactant, and a botanical extract of a plant selected from the Liliaceae and Cactus families, the extract retaining active enzymes and amino acids of the plant.

17. A method for the treatment of a surface of industrial equipment, comprising:
subjecting produce to an industrial cleaning process with industrial equipment so that the produce comes into contact with a surface of the industrial equipment; and
contacting the surface of the industrial equipment which has come into contact with the produce with a biocide, the biocide having a composition comprising aseptic water, a nonionic surfactant, and a botanical extract of a plant selected from the Liliaceae and Cactus families, the extract retaining active enzymes and amino acids of the plant.

18-26. (canceled)

27. The method of claim 10, wherein the biocide composition further comprises a pH adjusting agent present in an effective amount to establish the biocide composition at a pH in a range of about 3.1 to about 4.5.

28. The method of claim 27, wherein the pH adjusting agent comprises a fatty acid.

29. The method of claim 27, wherein the pH adjusting agent comprises citric acid.

30. The method of claim 10, further comprising a biologically derived second active enzyme.

31. The method of claim 30, wherein the second active enzyme is derived from Aspergillus spp.

32. The method of claim 10, wherein the nonionic surfactant comprises a polyoxyethylene sorbitan fatty acid ester.

33. The method of claim 10, wherein the botanical extract comprises an aloe.

34. The method of claim 33, wherein the aloe comprises Aloe barbadensis.

35. The method of claim 10, wherein:
the biocide composition further comprises a pH adjusting agent present in an effective amount to establish the produce-treatment composition at a pH in a range of about 3.1 to about 4.5;
the nonionic surfactant comprises a polyoxyethylene sorbitan fatty acid ester;
the botanical extract comprises Aloe barbadensis; and
the biocide composition further comprises a biologically derived second active enzyme.

36. The method of claim 10, wherein said contacting comprises spraying the biocide from 3 to 15 feet away from the produce.

37. The method of claim 10, wherein the produce comprises post-harvest fruit.

38. The method of claim 10, wherein the produce comprises post-harvest vegetables.

39. The method of claim 10, further comprising processing the extract under conditions that avoid substantial denaturing of natural active enzymes and amino acids of the plant.

40. The method of claim 39, wherein said conditions avoid heat processing at greater than 160° C. for more than 45 minutes.

41. The method of claim 13, wherein the botanical extract comprises Aloe barbadensis.

42. The method of claim 16, wherein the biocide composition further comprises a pH adjusting agent present in an effective amount to establish the produce-treatment composition at a pH in a range of about 3.1 to about 4.5.

43. The method of claim 42, wherein the pH adjusting agent comprises a fatty acid.

44. The method of claim 42, wherein the pH adjusting agent comprises citric acid.

45. The method of claim 16, further comprising a biologically derived active enzyme.

46. The method of claim 45, wherein the second active enzyme is derived from Aspergillus spp.

47. The method of claim 16, wherein the nonionic surfactant comprises a polyoxyethylene sorbitan fatty acid ester.

48. The method of claim 16, wherein the botanical extract comprises an aloe.

49. The method of claim 48, wherein the aloe comprises Aloe barbadensis.

50. The method of claim 16, wherein:
the biocide composition further comprises a pH adjusting agent present in an effective amount to establish the biocide composition at a pH in a range of about 3.1 to about 4.5;
the nonionic surfactant comprises a polyoxyethylene sorbitan fatty acid ester;
the botanical extract comprises Aloe barbadensis; and
the composition further comprises a biologically derived second active enzyme.

51. The method of claim 16, wherein said contacting comprises spraying the biocide from 3 to 15 feet away from the produce.

52. The method of claim 16, wherein the produce comprises post-harvest fruit.

53. The method of claim 16, wherein the produce comprises post-harvest vegetables.

54. The method of claim 16, further comprising processing the extract under conditions that avoid substantial denaturing of natural active enzymes and amino acids of the plant.

55. The method of claim 54, wherein said conditions avoid heat processing at greater than 160° C. for more than 45 minutes.

56. The method of claim 17, wherein the botanical extract comprises Aloe barbadensis.
